(19) United States
(12) Patent Application Publication
(10) Pub. No.: US 2013/0211874 A1
(43) Pub. Date: Aug. 15, 2013

(54) System and Method for Mass Production and Sale of Configurable and Personalized Tablet Computers

(71) Applicants: Bo Wu, Beijing (CN); Jun Sun, Beijing (CN); Yuhong Xiong, Beijing (CN)

(72) Inventors: Bo Wu, Beijing (CN); Jun Sun, Beijing (CN); Yuhong Xiong, Beijing (CN)

(73) Assignee: LaShou Group Inc., Grand Cayman (KY)

(21) Appl. No.: 13/370,522

(22) Filed: Feb. 10, 2012

(51) Int. Cl. G06Q 30/02

(52) U.S. Cl. 705/7.29

(57) ABSTRACT

A method to mass produce and sell electronic devices using open architecture manufacturing model and group-buying business model is provided. A group-buying company receives a plurality of offers to buy electronic devices from a plurality of consumers, and each offer is associated with a minimum requirement for each corresponding electronic device. The group-buying company determines one or more final device configurations of a plurality of electronic devices that satisfies the minimum requirements of all the offers, and all the electronic devices are substantially identical to be sold to the plurality of consumers as a group-buying deal. The group-buying company then arranges a single run of the identical electronic devices to be mass produced by a third entity. Finally, the group-buying company supplies the identical electronic devices to each of the plurality of consumers.

### TECHNICAL FIELD

The present invention relates generally to tablet computer, more particularly, to system and method for mass production and sale of configurable and personalized pad.

### BACKGROUND

Tablet computer, commonly called pad, has become popular in recent years, especially after the introduction of iPad from Apple in 2010. Many companies have manufactured various pads, but all of them follow a stovepipe model. That is, the pad is sold as a whole and is not configurable at the component level. In contrast, the personal computer (PC) industry follows an open architecture model, where the components of a PC (motherboard, CPU, memory, hard disk, power supply, display, case, etc.) have a standardized interface, so consumers have the option of choosing a specific configuration.

The stovepipe model has several drawbacks as compared to the open architecture model. First, there is limited selection when buying a pad. Consumers can only choose among existing, finished products, and are not able to get products with specific configuration. On the other hand, when buying a PC, consumers can choose a personalized configuration from many PC makers. For example, a consumer can specify that he wants a PC with a fast central processing unit (CPU), four-gigabit (4 GB) memory, a one terabit (1T) hard disk, a twenty-two-inch monitor, and so on, but pad buyers do not have this freedom. Second, the stovepipe model in general has a higher cost. In the open architecture model, many companies can make the same components so the cost of components can be very low, which in turn keeps the cost of the finished products low. In the pad industry, components are not standardized, so there is no mass component market, and each pad is made of a specific set of components, manufactured at low quantities. As a result, the cost of the components and the whole pad is relatively high. Third, there is no supporting upgrade for pads. A PC user can easily upgrade his computer. For example, the PC user can upgrade his computer by expanding the memory from 2 GB to 4 GB, replacing the mother board or the CPU, and/or replacing a graphic card. On the other hand, a pad user usually cannot upgrade his pad at the component level. Typically, the pad user has to buy a new pad when he wants to upgrade it. Fourth, it is hard to repair pads. Since components in a pad are not standardized, if one of the components in the pad stops working, then the consumer or a repair shop may have a hard time finding a replacement part.

### SUMMARY

This invention provides a method to mass produce and sell pads using the open architecture manufacturing model and the group-buying business model. Consumers can easily customize their needs when purchasing a pad, and the overall production cost is reduced.

A group-buying company receives a plurality of offers to buy electronic devices from a plurality of consumers, and each offer is associated with a minimum requirement for each corresponding electronic device. The group-buying company determines one or more final device configurations of a plurality of electronic devices that satisfies the minimum requirements of all the offers, and all the electronic devices are substantially identical and can be sold to the plurality of consumers as a group-buying deal. The group-buying company then arranges a single run of the identical electronic devices to be mass produced by a third entity. Finally, the group-buying company supplies the identical electronic devices to each of the plurality of consumers.

In one embodiment, the group-buying process for providing a personalized pad is implemented by a group-buying management server. The server comprises a user interface module for receiving user input via a group-buying website, a consumer-intent collection module for collecting consumer configurations, requirements, or intents to buy a pad, a consumer configuration processing module for automatically or semi-automatically choosing the desired configuration for each consumer, a multi-consumer configuration computation module for determining a final device configuration under a group-buying business model, a manufacture interface module for arranging mass production of the pads via a third-party entity, an automatic customized software configuration module for automatically configuring and installing software for the pads, and an upgrade and repair module for providing upgrade and repair service for the pads.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an online group-buying system providing group-buying deals for electronic devices in accordance with one novel aspect.

FIG. 2 illustrates a simplified block diagram of a tablet computer.

FIG. 3 is a flow chart of a method of mass production and sale of tablet computers in accordance with one novel aspect.

FIG. 4 illustrates a detailed process of providing group-buying deals for tablet computers.

FIG. 5 is a user interface for receiving direct consumer configuration to buy a pad.

FIG. 6 is a user interface of receiving indirect consumer intent to buy a pad.

FIG. 7 illustrates a smart algorithm that determines configuration from consumer intent.

FIG. 8 illustrates a process of automatically choosing product configurations for multiple users applying different group-buying models.

FIG. 9 illustrates a process of automatic customized software configuration.

### DETAILED DESCRIPTION

Reference will now be made in detail to some embodiments of the invention, examples of which are illustrated in the accompanying drawings.

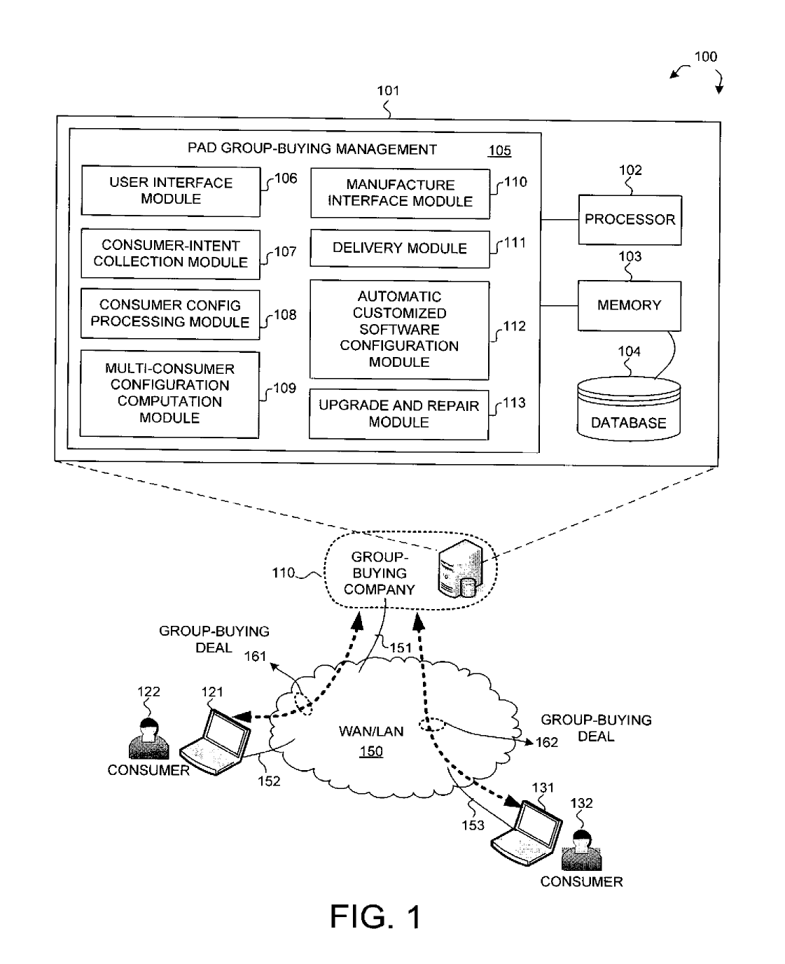

FIG. 1 illustrates an online group-buying system 100 that provides group-buying deals for electronic devices in accordance with one novel aspect. Online group-buying system 100 comprises a group-buying server computer 101 used by a group-buying company 110, a first laptop computer 121 used by a first consumer 122, a second laptop computer 131 used by a second consumer 132, and a wireless area network (WAN) or local area network (LAN) WAN/LAN 150. Group-buying server 101 comprises a processor 102, memory 103, a database 104, and a group-buying management module 105. Group-buying management module 105 in turn comprises a user-interface module 106, a consumer-intent collection module 107, a consumer configuration processing module 108, a multi-consumer configuration computation module 109, a manufacture-interface module 110, a delivery module 111, an automatic customized software configuration module 112, and an upgrade and repair module 113.

In one embodiment, group-buying deals are conducted by exchanging communication messages in group-buying system 100 via WAN/LAN 150 (e.g., group-buying server 101, laptop computer 121, and laptop computer 131 are connected to WAN/LAN 150 via wired or wireless links 151, 152, and 153 respectively). The different modules within group-buying server 101 are function modules that may be running on the same or different computer servers. The function modules, when executed by processor 102, allow consumers 122 and 132 and other consumers together to buy personalized electronic devices at a discounted price.

In one example, online group-buying company 110 advertises a certain type of electronic device (e.g., a tablet computer) for sale via a group-buying website. Consumer 122 submits a first offer with a first user requirement to buy this type of electronic device, and consumer 132 submits a second offer with a second user requirement to buy the same type of electronic device. More and more consumers submit their offers to buy the same type of electronic devices. When the total number of buyers reaches a threshold number, the group-buying company determines one or more final device configurations that satisfy all consumer requirements. The electronic devices with the same final device configuration are mass produced with lower cost and sold to the consumers as a group-buying deal with discounted price.

In one novel aspect, the consumers can easily customize their personal needs when purchasing an electronic device such as a tablet computer (commonly called pad), and the overall production cost is reduced by utilizing both an open architecture manufacturing model and a group-buying business model. First, hardware components, device driver interfaces, and software options of all pads are standardized so that the consumers will have the option of choosing a specific configuration. Second, group-buying business models are used to collect and process multiple-consumer purchasing requirements, so that mass production and sale of pads become possible to increase user satisfaction and supplier profitability.

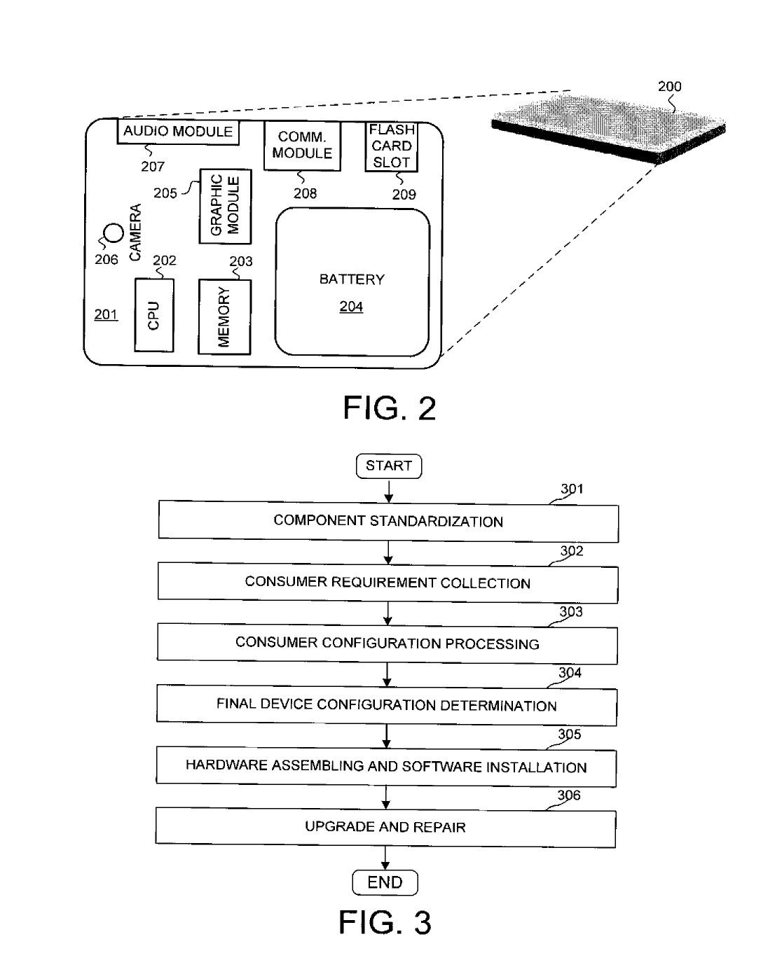

FIG. 2 illustrates a simplified block diagram of a tablet computer 200. Tablet computer 200 comprises a motherboard 201, a central processing unit (CPU) 202, memory 203, a battery unit 204, a graphic module 205 for a display and touch screen (not shown), a camera 206, an audio module 207, a communication module 208, and a flash card slot 209. The communication module may include a Wi-Fi module, a Bluetooth module, a 3G/LTE radio frequency (RF) module, and/or a near field communication (NFC) module, etc. The tablet computer 200 may also include other hardware components and accessories—such as a global positioning system (GPS) module, an orientation sensor, an ambient light sensor, a power supply/charger, and a case and several buttons. The various hardware components have standardized interfaces. For example, the CPU can have a different model/clock frequency, the memory can have different capacities, the touch screen may have different sizes, the touch screen may or may not support a stylus, and the camera may have different resolutions, etc.

In addition to the hardware components, all the devices such as touch screen, flash card, communication modules, camera, GPS, graphic module, audio module, orientation sensor, and ambient light sensor have standard driver interfaces, so “plug-and-play” can be achieved. Furthermore, software options like the operation system (OS), the user interface (UI) style, and various software applications are also standardized. Examples of software options may include Android OS, mobile versions of Windows OS, different UI schemes, and different sets of software applications.

FIG. 3 is a flow chart of a method of mass production and sale of tablet computers in accordance with one novel aspect. In step 301, an online group-buying company advertises pads supporting standardized hardware and software options. Component manufactures make pad components based on standard hardware and software interfaces. For each type of components, consumers and pad assemblers will have a wide variety to choose from, with different price and performance levels. In step 302, consumer requirements for buying a pad are collected by the online group-buying company. The consumers specify, either directly or indirectly, pad configurations by submitting their purchasing intents and needs to a group-buying server via user interfaces provided by a group-buying website (e.g., via consumer-intent collection module 107). In step 303, the purchase intents and needs are processed (e.g., via consumer configuration processing module 108). For example, a smart algorithm may be used to automatically or semi-automatically choose the desired configuration for each consumer based on his needs. In step 304, one or more device configurations are determined based on the consumer requirements collection and consumer configuration processing (e.g., via multi-consumer configuration computation module 109). For example, a smart algorithm is used to automatically choose the best device configurations for multiple users to increase consumer satisfaction and supplier profitability.

In step 305, hardware assembling and software installation are performed. The online group-buying company arranges a third-party assembler to obtain all the standardized hardware components and assemble them together according to the computed final device configurations (e.g., via manufacture-interface module 110). The pad assembler may also install the software stacks using a software configuration tool provided by the online group-buying company (e.g., via automatic customized software configuration module 112). Finally, in step 306, if a pad needs a hardware upgrade or repair, some of the hardware components are replaced, and the software configuration tool can be used to install the new device driver (e.g., via upgrade and repair module 113).

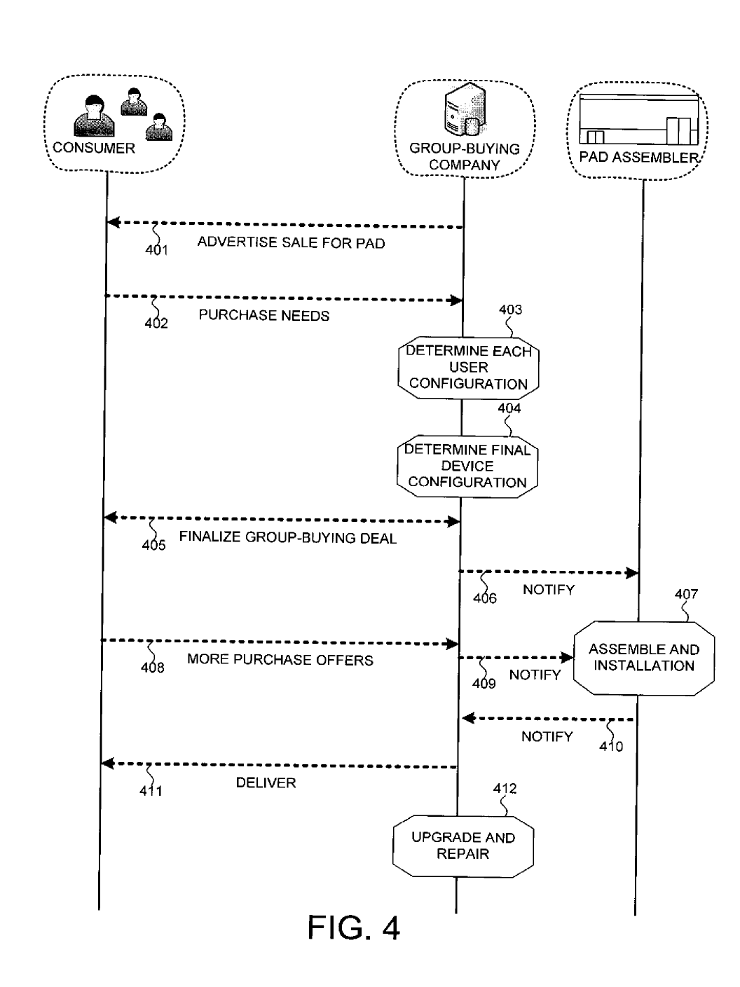

FIG. 4 illustrates a detailed process of providing group-buying deals to consumers buying tablet computers in an online group-buying system. The online group-buying system comprises a plurality of consumers, a group-buying company, and a pad assembler. In step 401, the group-buying company advertises via a group-buying website for a plurality of consumers to buy personalized pads supporting standardized hardware and software options. In step 402, the consumers, either directly or indirectly, specify via user interfaces their personal requirements for the pads they intend to buy. In one example, the consumers directly pick the hardware and software options for the pad. In another example, the consumers indirectly specify the requirements for the pad.

In step 403, the online group-buying company, via a group-buying server computer, collects and processes the requirements for each consumer. For example, if a consumer indirectly specifies a minimum requirement, then the group-buying server processes the minimum requirement to a corresponding hardware and software configuration. In step 404, the group-buying server applies various group-buying business models to determine one or more final device configurations to control production cost. As a result, each of the final device configurations satisfies all requirements for a group of consumers, such that mass pad production is possible to reduce the overall production cost. In general, the performance of the chosen final device configurations is the same as or higher than each of the individual configurations selected by each consumer to increase consumer satisfaction. Meanwhile, the chosen final device configurations are substantially identical for the group of consumers, such that all the pads for the same group can be mass produced with lower manufacturing costs to increase supplier profitability.

Three group-buying business models may be applied. In a first model, the overall purchase price is fixed. Consumers select their needed pad functions, but the total price of the pad functions must not exceed the fixed overall price. The number of consumers has to exceed a certain threshold number. Once the group-buying process is finished, all the orders must be fulfilled. In a second model, the overall purchase price can be varied. Consumers select their needed pad functions, but the total price must exceed a preset minimum price. The number of consumers has to exceed a certain threshold number. Once the group-buying process is finished, all the orders must be fulfilled. In a third model, consumers can select their needed pad functions and specify a maximum affordable overall price. Once the group-buying process is finished, some of the order might not be fulfilled. If no suitable configurations can be obtained for a consumer at the maximum affordable price specified by the consumer, then the group-buying order is not fulfilled for this particular consumer.

The group-buying process may be carried out interactively with the user. In step 405, a group-buying deal is finalized between the consumer and the group-buying company—with a determined final device configuration, a purchase price, and a total number of orders. In step 406, the group-buying company notifies the third-party pad assembler. In step 408, the pad assembler obtains all the hardware components and puts them together according to the determined final device configuration. The pad assembler also installs the software stacks accordingly. Before the pad assembler completes the mass production for all pads, additional orders from the consumers may be accepted. For example, in step 408, the group-buying company accepts more purchase orders from consumers buying pads with the same device configuration. In step 409, the group-buying company notifies the pad assembler for the additional orders, which can be mass produced together with the previous orders at a lower cost. One advantage is, when more consumers participate, the purchase price can decrease automatically. In step 410, the pad assembler notifies the group-buying company that all the new pads are made. In step 411, the group-buying company delivers the new pads to each of the group of consumers. Finally, in step 412, hardware upgrade or repair may be performed upon a request from the consumers.

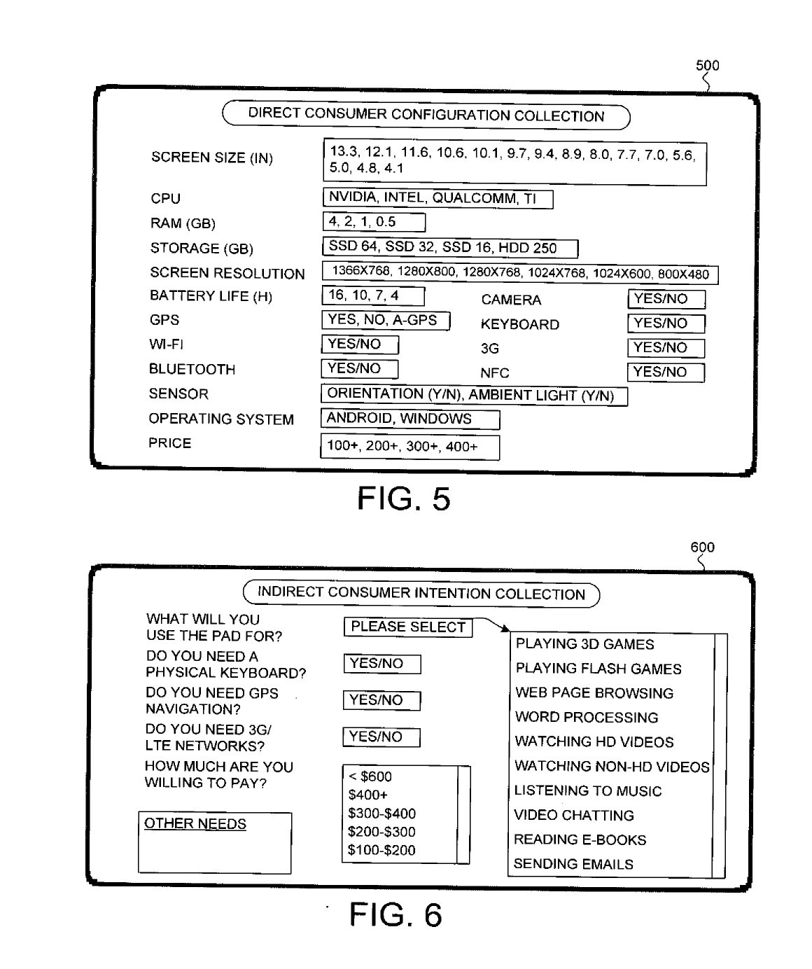

FIG. 5 is a user interface 500 for receiving direct consumer configuration to buy a pad. User interface 500 comprises a list of hardware configuration options for collecting user input. Each option is in the form of multiple choices. For example, for screen size, the user may choose from fifteen sizes ranging from 13.3 to 4.1 (Inch). For CPU, the user may choose from six selections—including two Nvidia Tegra ARM processors, two Intel processors, one Qualcomm processor, and one TI processor. For Random access memory (RAM), the user may choose from 4, 4, 1, or 0.5 (GB). For Storage, the user may choose from SSD 64 GB, SSD 32 GB, SSD 16 GB, or HDD 250 GB. For screen resolution, the user may choose from six selections—including 1366×768, 1280×800, 1280×768, 1024×768, 1024×600, and 800×480. For Battery life, the user may choose from 16, 10, 7, or 5 (Hour). For other options such as Camera, GPS, physical keyboard, Wi-Fi, Bluetooth, 3G, NFC, orientation sensor, and ambient light sensor, the user may choose YES or NO to specify whether such options are desired or not. For operating system, the user may choose from Android Honeycomb, Android Froyo, Windows 7 professional, or Windows 7 Home Premium. Finally, the user may also specify a price range or maximum price depending on the group-buying model applied.

FIG. 6 is a user interface 600 for receiving indirect consumer intent to buy a pad. User interface 600 comprises a list of text-based questions to be answered by the user when buying a pad. Each question can be answered in the form of multiple choices. For example, a first question may be “What will you use the pad for?” The user may select from ten choices that includes playing 3D games, playing flash games, web page browsing, word processing, presentation and spreadsheet, watching HD videos, watching non-HD videos, listening to music, video chatting, reading e-books, or sending emails. A second question may be “Do you need a physical keyboard?” A third question may be “Do you need GPS navigation?” A fourth question may be “Do you need 3G/LTE networks?” All those questions may be answered by a simple YES or NO. A fifth question may be “How much money are you willing to pay?” The user may provide a price range such as $100-$200, $200-$300, $300-$400, $400+, or <$600. In addition, the user may also enter other special requirements or needs via the “Other Needs” field. Based on the user answers to those questions, a computer smart algorithm may then be used to pick a corresponding user configuration.

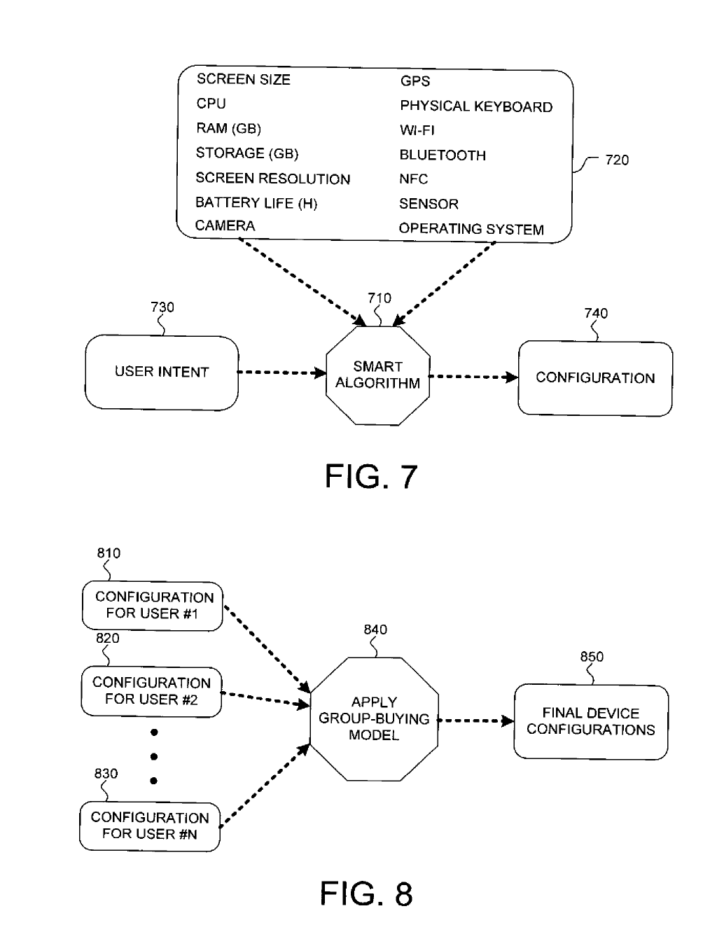

FIG. 7 illustrates a smart algorithm 710 that determines user configuration from consumer requirement or intent. In the example of FIG. 7, box 720 depicts a list of hardware and software configuration options, box 730 depicts a set of consumer requirements/intents, and box 740 depicts a corresponding user configuration determined by smart algorithm 710. In one example, the user intent may be summarized as “I want to buy a pad for a lady over age 60, her main usage will be reading e-books, and I want the cost of the pad to be below $200.” Based on this user intent, smart algorithm 710 determines the configuration from the list of hardware and software options, which is likely to be “A pad with a large display, a low cost CPU and motherboard, a 3G and Wi-Fi interface, an UI with big icon, and an e-book software application.”

After collecting and processing the requirements for each consumer, a group-buying business model is applied to determine one or more final device configurations for mass production. In one advantageous aspect, a smart algorithm may be used to automatically choose the best device configurations that satisfy each consumer based on a particular group-buying business model. FIG. 8 illustrates a process of automatically choosing device configurations for multiple users applying different group-buying models. In the example of FIG. 8, box 810 represents a user configuration for user #1, box 820 represents a user configuration for user #2 (user #3, user #4, et al.), and box 830 represents a user configuration for user #N. Based on the configurations for all the users, a smart algorithm 840 applies a group-buying model and determines one or more final device configurations 850 for all the users, unless no suitable configuration can be obtained with the maximum affordable price.

In one example, there are three groups of consumers with different requirements. A first group of consumers will use the pad for watching HD videos and playing 3D games. A second group of consumers will use the pad mainly for playing flash games and reading online news. A third group of consumers will use the pad mainly for instant messaging and sending emails. For the first group, the desired configuration probably involves a high-resolution screen, a high performance graphics card, and a long battery life. For the second group, a medium-resolution screen, a medium performance graphics card, and a medium battery life are needed. For the third group, a low-resolution screen, a cheap graphics card, and a short battery life are sufficient. However, if there are much less consumers in the first and the third groups than in the second group, then the smart algorithm might choose to produce only two final device configurations for two types of pads. The first group and part of the second group of consumers will receive high-end pads with high-resolution screens, high-performance graphics cards, and long battery lives. The third group of consumers and part of the second group of consumers will receive medium-end pads with medium-resolution screens, medium-performance graphics cards, and medium battery lives. In this way, the overall production cost may be lower than producing all three types of pads for these consumers. In addition, some consumers can get their pads with performance exceeding their expectation for the same price.

In one advantageous aspect, after a pad has been assembled, a software tool may be used to configure the software in the pad. The software tool runs on a separate computer, like a PC, and the PC is connected to the pad via different types of communication links, including a direct wired connection such as through USB, a wireless connection such as through Wi-Fi, or a remote connection such as through the Internet. Based on the configuration of the pad, the software tool can install the complete software stack on the pad, including the operating system, the device drivers, and the application—without or with minimum human intervention.

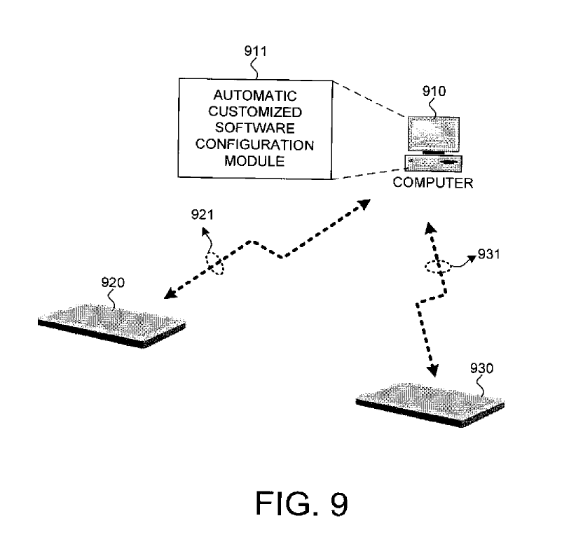

FIG. 9 illustrates a process of automatic customized software configuration. In the example of FIG. 9, a computer 910 comprises an automatic customized software configuration module 911 to install software for pad 920 and pad 930 via wired/wireless/remote communication links 921 and 931 respectively. It is noted that different software options may be installed for two consumers even if the hardware configurations are exactly the same. For example, one consumer bought pad 920 and likes reading e-books, while another consumer bought pad 930 and reads presentation slides a lot. Both of them need a good screen and long battery life. However, better e-book related software (e.g., has more capabilities but may be more expensive and consumes more computer resources) will be installed on pad 920, while better presentation software will be installed on pad 930. Later, if pad 920 or pad 930 needs a hardware upgrade or repair, some of the hardware components can be replaced, and the software configuration tool 911 can be used to install the new device driver if needed.

In one or more exemplary embodiments, the functions described above may be implemented in hardware, software, firmware, or any combination thereof. If implemented in software, the functions may be stored on or transmitted over as one or more instructions or code on a computer-readable (processor-readable) medium. Computer-readable media include both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that both can be used to carry or store desired program code in the form of instructions or data structures and can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies are included in the definition of medium. Disk and disc, as used herein, include compact disc (CD), laser disc, optical disc, digital versatile disc (DVD), floppy disk, and blue-ray disc where disks usually reproduce data magnetically, while discs reproduce data optically with lasers. Combinations of the above should also be included within the scope of computer-readable media.

Although the present invention has been described in connection with certain specific embodiments for instructional purposes, the present invention is not limited thereto. For example, although tablet computers or pads are used as one example, the illustrated method may be applied to other electronic devices such as smart phones. Accordingly, various modifications, adaptations, and combinations of various features of the described embodiments can be practiced without departing from the scope of the invention as set forth in the claims.

What is claimed is:

1. A computer server system, comprising:
a consumer-intent collection module that receives a plurality of offers to buy electronic devices from a plurality of consumers, wherein each offer is associated with a minimum requirement for each corresponding electronic device;
a multi-consumer configuration computation module that determines a final device configuration of a plurality of electronic devices that satisfies the minimum requirements of all the offers, wherein the plurality of electronic devices can be mass produced in a single run, and wherein all the electronic devices of the single run are substantially identical to be sold to the plurality of consumers as a group-buying deal;
a manufacture-interface module that arranges to have a run of the identical electronic devices mass produced by a third entity; and
a delivery module that supplies the identical electronic devices of the run to each of the plurality of consumers.

2. The server system of claim 1, wherein the minimum requirement is processed to a corresponding user configuration via a smart algorithm.

3. The server system of claim 2, wherein the final device configuration provides the same or better performance as compared to each user configuration.

4. The server system of claim 1, wherein a total number of sales for the plurality of electronic devices exceeds a threshold number to qualify for the group-buying deal.

5. The server system of claim 4, wherein each of the plurality of electronic devices is sold for a price, and wherein the price automatically decreases when the total number of sales increases.

6. The server system of claim 4, wherein each offer specifies a purchase price, and wherein a cost of mass producing the plurality of electronic devices is substantially less than a sum of all the purchase prices.

7. The server system of claim 1, wherein some of the plurality of offers are accepted after the final device configuration is determined and before the plurality of electronic devices is supplied.

8. The server system of claim 1, wherein the electronic device is a tablet computer, and wherein the final device configuration includes CPU selection, memory size, screen size and resolution, and battery capacity.

9. The server system of claim 8, wherein each electronic device has a plurality of hardware components and device drivers, and wherein the interfaces of the hardware components and device drivers are standardized.

10. The server system of claim 8, wherein each electronic device has a plurality of software options, and wherein the software options are standardized.

11. A method comprising:
(a) receiving a plurality of offers to buy electronic devices from a plurality of consumers, wherein each offer is associated with a minimum requirement for each corresponding electronic device;
(b) determining a final device configuration of a plurality of electronic devices that satisfies the minimum requirements of all the offers in (a), wherein the plurality of electronic devices can be mass produced in a single run, and wherein all the electronic devices of the single run are substantially identical to be sold to the plurality of consumers as a group-buying deal;
(c) arranging to have a run of the identical electronic devices mass produced by a third entity; and
(d) supplying the identical electronic devices of the run to each of the plurality of consumers.

12. The method of claim 11, wherein the minimum requirement is processed to a corresponding user configuration via a smart algorithm.

13. The method of claim 12, wherein the final device configuration provides the same or better performance as compared to each user configuration.

14. The method of claim 11, wherein a total number of sales for the plurality of electronic devices exceeds a threshold number to qualify for the group-buying deal.

15. The method of claim 14, wherein each of the plurality of electronic devices is sold for a price, and wherein the price automatically decreases when the total number of sales increases.

16. The method of claim 14, wherein each offer specifies a purchase price, and wherein a cost of mass producing the plurality of electronic devices is substantially less than a sum of all the purchase prices.

17. The method of claim 11, further comprising:
(e) accepting the plurality of offers of (a), wherein the accepting of (e) occurs after the determining of (b) and before the supplying of (d).

18. The method of claim 11, wherein the electronic device is a tablet computer, and wherein the final device configuration includes CPU selection, memory size, screen size and resolution, and battery capacity.

19. The method of claim 18, wherein each electronic device has a plurality of hardware components and device drivers, and wherein the interfaces of the hardware components and device drivers are standardized.

20. The method of claim 18, wherein each electronic device has a plurality of software options, and wherein the software options are standardized.
